(19) United States
(12) Patent Application Publication
(10) Pub. No.: US 2020/0011090 A1
(43) Pub. Date: Jan. 9, 2020

(54) SWITCH DEVICE

(71) Applicant: CANDY HOUSE INC., Palo Alto, CA (US)

(72) Inventors: Che-Ming KU, Taipei City (TW); Wen-Hang SU, Palo Alto, CA (US)

(21) Appl. No.: 16/504,094

(22) Filed: Jul. 5, 2019

Related U.S. Application Data
(60) Provisional application No. 62/694,452, filed on Jul. 6, 2018.

(51) Int. Cl. E05B 47/00; E05B 47/06

(52) U.S. Cl. CPC E05B 47/0004; E05B 2047/0022; E05B 47/0603

(57) ABSTRACT

A switch device includes a moving unit, a manual unit, a plurality of securing members and an actuating mechanism. The moving unit includes a ring gear, first and second sliding members, and a first connecting member. The first and second sliding members are slidable relative to the ring gear and respectively in mutually perpendicular directions. The securing members extend through the first connecting member and the first sliding member into the manual unit for securing the first sliding member between the first connecting member and the manual unit. The actuating mechanism is co-movably connected to the second sliding member and is adapted for actuating operation of a lock mechanism.

### CROSS-REFERENCE TO RELATED APPLICATION

This application claims priority of U.S. Provisional Patent Application No. 62/694,452, filed on Jul. 6, 2018.

### FIELD

The disclosure relates to a switch device, and more particularly to a switch device for controlling operation of lock or switch mechanisms.

### BACKGROUND

A conventional electromechanical lock device, or “smart lock”, disclosed in U.S. Patent Publication No. 2009/0084147A1 is adapted for operating a rotary button of a door lock. The lock device includes a cover device mounted on a door leaf and covering the rotary button of the door lock, and a control device for electrically controlling the cover device. The cover device of the conventional lock device includes a round transmission member that has a plurality of holding rib pieces fittingly holding the rotary button therebetween in order to drive rotation of the rotary button. However, since the holding rib pieces are fixedly connected to the transmission member, the conventional lock device has limited compatibility, that is, it can only be used with some specific types of rotary buttons, and cannot be adjusted to actuate lock mechanisms with the rotary buttons having different sizes or being provided at different positions with respect to the covering device. Moreover, the conventional electromechanical lock device cannot be used to control switch mechanisms such as a push-button switch or a proximity switch.

### SUMMARY

Therefore, the object of the disclosure is to provide switch device that is compatible with different types of lock or switch mechanisms.

According to the disclosure, a switch device adapted for controlling operation of a lock mechanism includes a casing, a power unit, a moving unit, a manual unit, a plurality of securing members and an actuating mechanism.

The power unit is disposed in the casing. The moving unit is disposed in the casing, and includes a rotating subunit and a sliding subunit. The rotating subunit includes a ring gear that is driven rotatably by the power unit about a rotational axis. The sliding subunit includes a first sliding member, a second sliding member and a first connecting member. The first sliding member is co-rotatably connected to the ring gear, is slidable relative to the ring gear along a first axis which is perpendicular to the rotational axis, and is formed with a sliding slot that extends along the first axis. The second sliding member is co-movably connected to the first sliding member, and is slidable relative to the first sliding member along a second axis which is perpendicular to the first axis and the rotational axis. The first connecting member is connected to the first sliding member.

The manual unit is coupled co-rotatably to the ring gear. The securing members are arranged along the first axis, and extend through the first connecting member and the sliding slot of the first sliding member into the manual unit, such that the first sliding member is secured between the first connecting member and the manual unit. The actuating mechanism is co-movably connected to the second sliding member and is adapted for actuating operation of the lock mechanism during the rotation of the ring gear.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a first embodiment of a switch device according to the disclosure;

FIG. 2 is a partly exploded perspective view of the first embodiment;

FIG. 3 is an exploded perspective view illustrating a sliding subunit of a moving unit, a ring gear, and a resistor member of the angle sensing unit of the first embodiment;

FIG. 4 is a partly perspective cutaway view of the first embodiment;

FIG. 5 is a perspective view of a manual unit of the first embodiment;

FIG. 6 is a partly perspective cutaway view of the manual unit of the first embodiment;

FIG. 7 is a perspective view of the ring gear and the angle sensing unit of the first embodiment;

FIG. 8 is another perspective view of the ring gear and the angle sensing unit of the first embodiment;

FIG. 9 is an exploded perspective view of the ring gear and the resistor member of the first embodiment;

FIG. 10 is a fragmentary perspective view of a power unit, a solenoid valve unit, and a planetary gear set of the moving unit of the first embodiment;

FIG. 11 is an exploded perspective view of the solenoid valve unit of the first embodiment;

FIG. 12 is a partly perspective cutaway view of the solenoid valve unit of the first embodiment;

FIG. 13 is an assembled perspective view of a second embodiment of the disclosure;

FIG. 14 is a partly exploded perspective view of the second embodiment;

FIG. 15 is a fragmentary exploded perspective view of a pin unit of the second embodiment;

FIG. 16 is a partly perspective cutaway view of the second embodiment;

FIG. 17 is an assembled perspective view of a variation of the second embodiment of the disclosure;

FIG. 18 is a partly perspective cutaway view of the variation of the second embodiment;

FIG. 19 is a perspective view of a third embodiment of the disclosure; and

FIGS. 20 and 21 are perspective views of a fourth embodiment of the disclosure, illustrating a turning unit having a telescopic structure.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

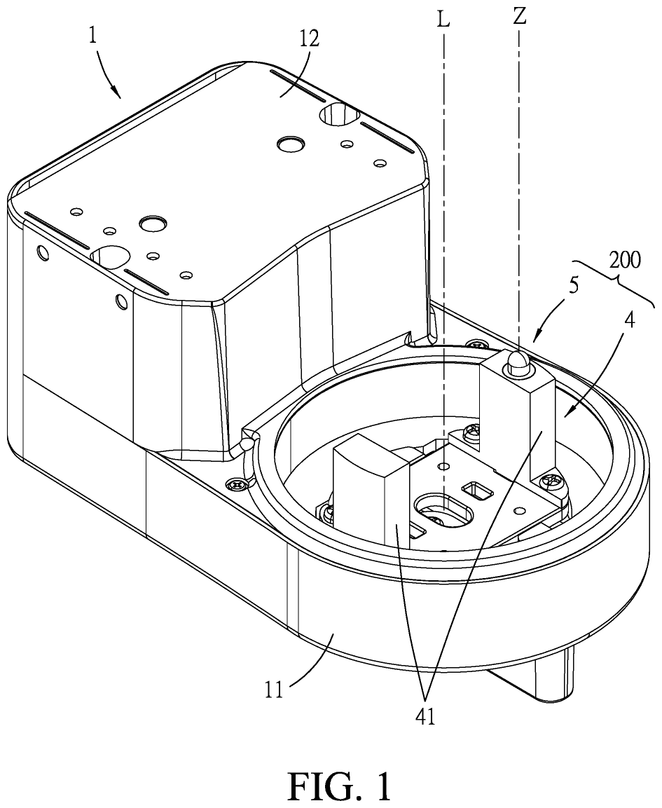

Referring to FIGS. 1, 2 and 3, a first embodiment of a switch device according to the disclosure is adapted for controlling operation of a lock mechanism or a switch mechanism. The switch device includes a casing 1, a power unit 2, a moving unit 3, a manual unit 6, an angle sensing unit 7, a solenoid valve unit 8, a plurality of securing members 101 and an actuating mechanism 200.

The casing 1 has a first portion 11 and a second portion 12. The first and second portions 11, 12 cooperatively form an L-shaped structure. The power unit 2 is disposed in the second portion 12 of the casing 1. The moving unit 3 is disposed in the casing 1, and includes a rotating subunit 31 and a sliding subunit 32.

The rotating subunit 31 includes a planetary gear set 311 and a ring gear 312.

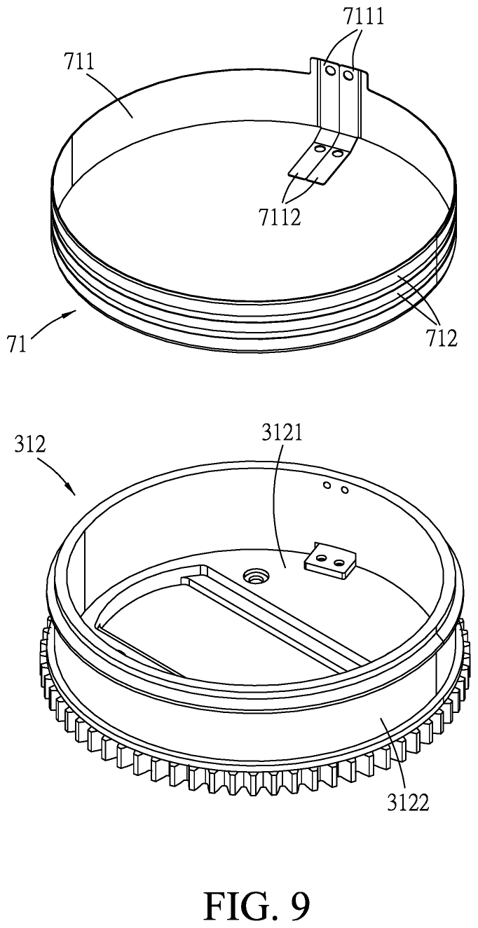

The planetary gear set 311 is connected to and is driven rotatably by the power unit 2, and has a plurality of external teeth 3111. The ring gear 312 is disposed in the first portion 11 of the casing 1, and has a round base wall 3121, a plurality of teeth 3123 provided on a periphery of the base wall 3121, and an annular surrounding wall 3122 protruding from the periphery of the based wall 3121 and formed with a plate hole 3124 (see FIG. 8). The external teeth 3111 of the planetary gear set 311 mesh with the teeth 3123 of the ring gear 312 so that the rotation of the planetary gear set 311 drives the ring gear 312 to rotate about a rotational axis (L).

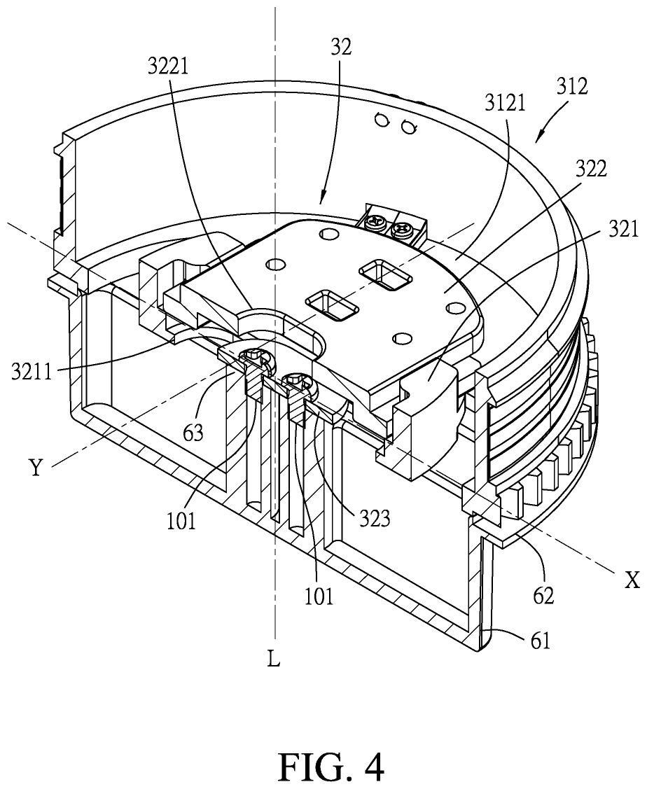

Referring further to FIG. 4, the sliding subunit 32 includes a first sliding member 321, a second sliding member 322 and a first connecting member 323. The first sliding member 321 is co-rotatably connected to the base wall 3121 of the ring gear 312 of the rotating subunit 31, is slidable relative to the ring gear 312 along a first axis (X) which is perpendicular to the rotational axis (L), and is formed with a sliding slot 3211 that extends along the first axis (X). The second sliding member 322 is co-movably connected to the first sliding member 321, is slidable relative to the first sliding member 321 along a second axis (Y) which is perpendicular to the first axis (X) and the rotational axis (L), and is formed with a fastening hole 3221. The first connecting member 323 is entirely retained in the sliding slot 3211 and is connected to the first sliding member 321.

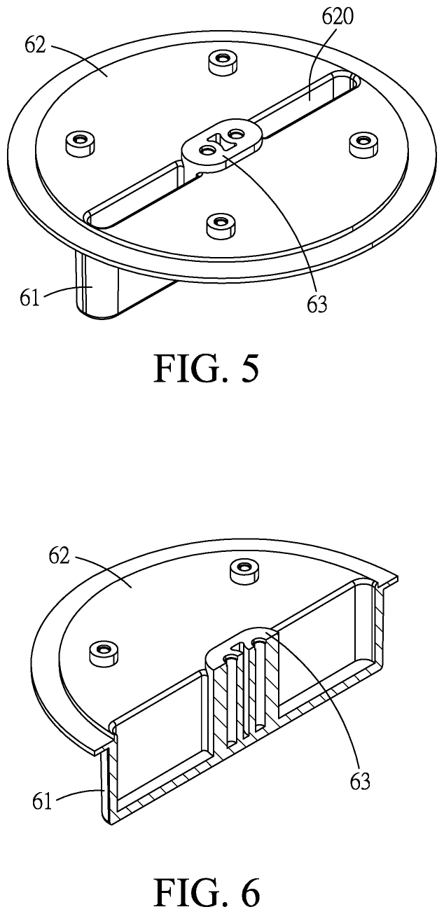

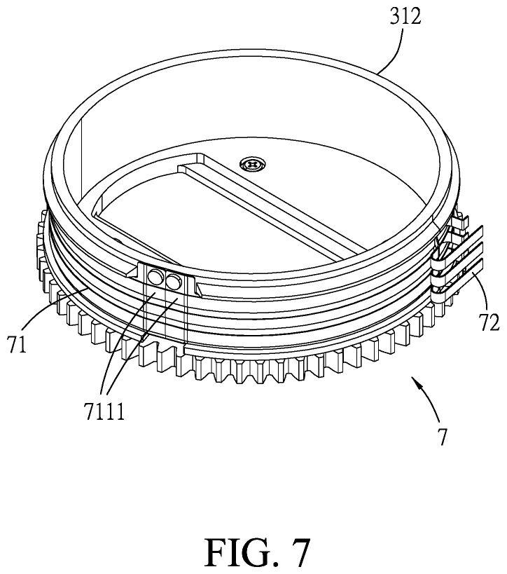

Referring further to FIGS. 5 and 6, the manual unit 6 includes a round base member 62, a handle 61 and a second connecting member 63. The base member 62 is coupled co-rotatably to the base wall 3121 of the ring gear 312 of the rotating subunit 31 of the moving unit 3, and is formed with a coupling slot 620. The handle 61 is mounted to the base member 62, and has an internal space being in spatial communication with the coupling slot 620 of the base member 62. The second connecting member 63 is connected to the base member 62, is disposed at the coupling slot 620, and is connected to the first connecting member 323.

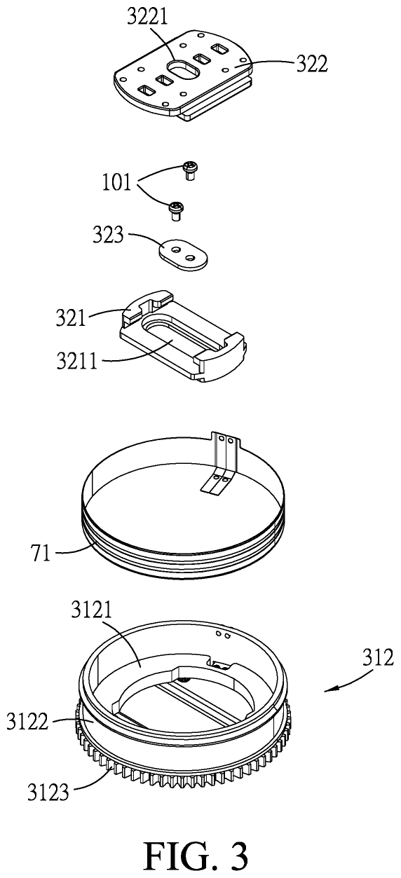

Referring to FIGS. 3 and 4, in the present embodiment, the securing members 101 are configured as screws. The securing members 101 are arranged along the first axis (X), and extend through the first connecting member 323 of the moving unit 3, the sliding slot 3211 of the first sliding member 321 of the moving unit 3, the second connecting member 63 of the manual unit 6, the coupling slot 620 of the base member 62 of the manual unit 6, and then into the internal space of the handle 61 of the manual unit 6, such that the first sliding member 321 is secured between the first connecting member 323 of the moving unit 3 and the second connecting member 63 of the manual unit 6. The securing members 101 are exposed from the fastening hole 3221 of the second sliding member 322, so that the securing members 101 may be easily installed or removed via the fastening hole 3221.

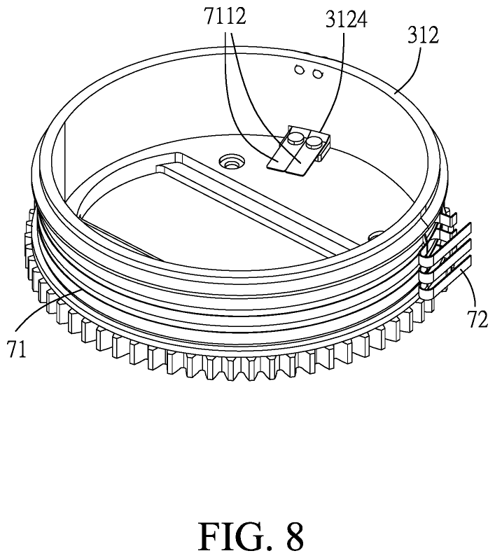

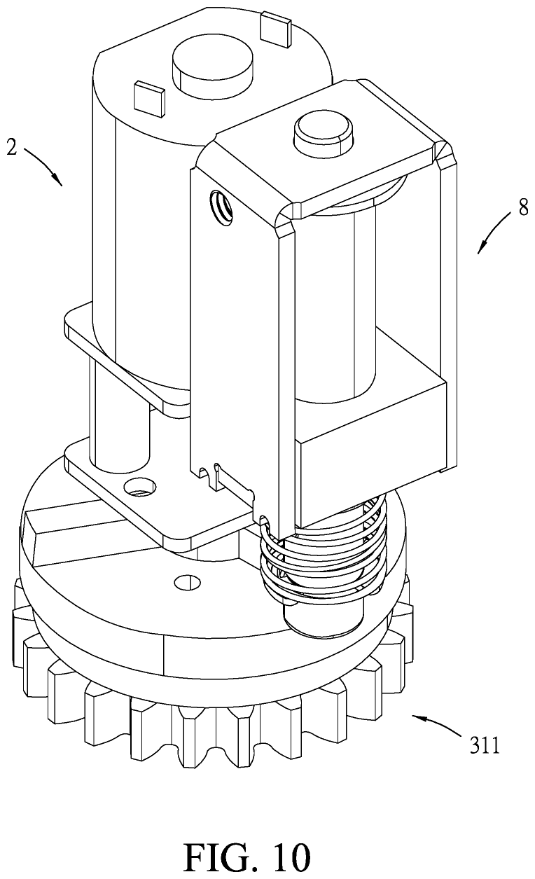

Referring to FIGS. 7, 8 and 9, the angle sensing unit 7 includes a brush 72 and a resistor member 71.

The brush 72 is disposed in the second portion 12 of the casing 1, and is electrically connected to the power unit 2.

The resistor member 71 includes a flexible plate 711 and a conductive trail 712. The flexible plate 711 has an elongated plate body wrapped around the surrounding wall 3122 of the ring gear 312, and has longitudinally-opposite end sections. Each of the end sections is formed with laterally-opposite first and second end projections 7111, 7112. The first end projections 7111 of the two end sections of the flexible plate 711 are directly connected to each other and are fastened to the surrounding wall 3122. The second end projections 7112 of the two end sections of the flexible plate 711 are directly connected to each other, extend through the plate hole 3124 of the surrounding wall 3122, and are fastened to the base wall 3121 of the rotating subunit 31 of the moving unit 3. The conductive trail 712 is wrapped around the flexible plate 711, and is in slidable contact with the brush 72 such that the conductive trail 712 is constantly in electrical connection with the brush 72.

Further details and operation of the angle sensing unit 7 are disclosed in U.S. Patent Publication No. US2016/0341537A1 and are not be described hereinafter.

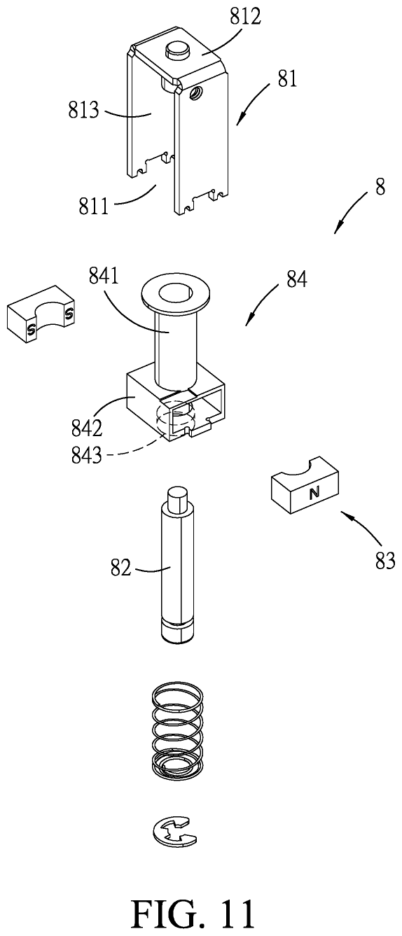

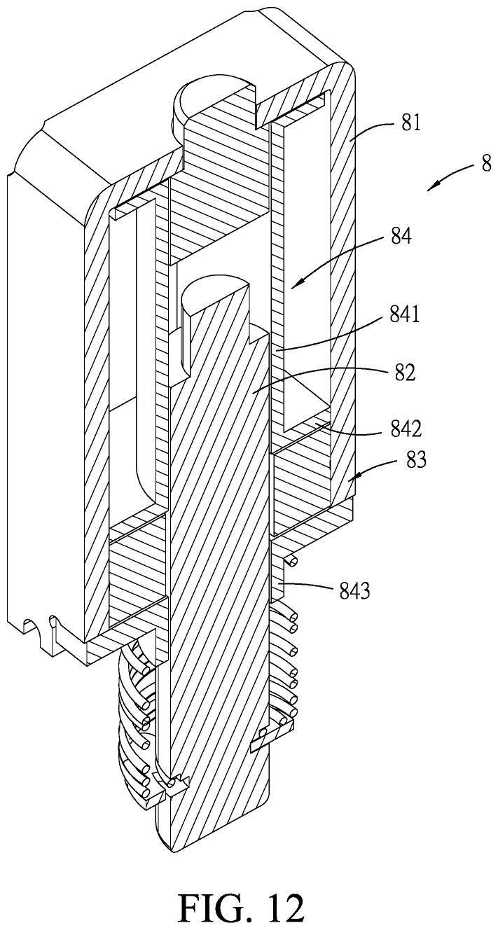

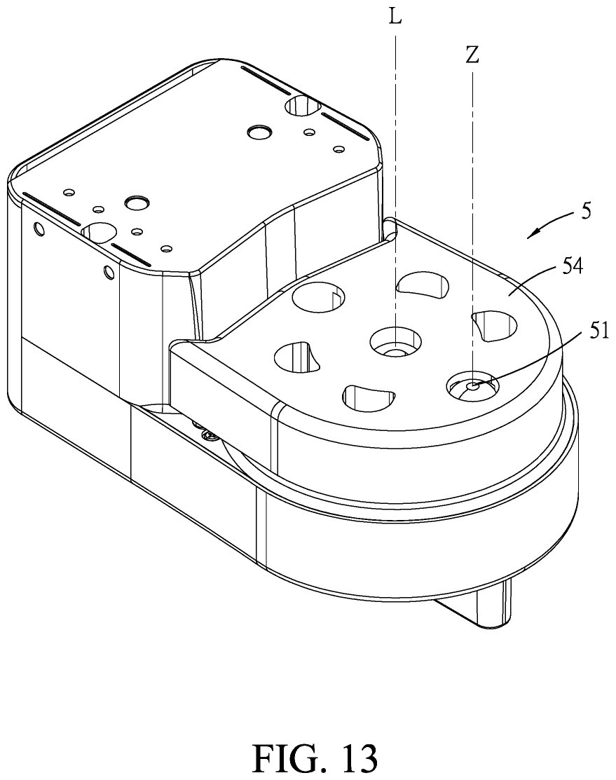

Referring to FIGS. 10, 11 and 12, the solenoid valve unit 8 is disposed in the second portion 12 of the casing 1, is adjacent to the planetary gear set 311 of the moving unit 3, and is electrically connected to the power unit 2. The solenoid valve unit 8 includes a case member 81, a shaft rod 82, a solenoid subunit 83 and a tube member 84.

The case member 81 defines a retaining space 813 therein, and has an opening 811 in spatial communication with the retaining space 813, and a closed end 812 opposite the opening 811.

The tube member 84 includes a first tube portion 841, a hollow receiving portion 842 and a second tube portion 843. The first tube portion 841 is disposed in the retaining space 813 of the case member 81. The second tube portion 843 is disposed outside of the retaining space 813. The hollow receiving portion 842 is disposed at the opening 811 of the case member 81, and interconnects and is in spatial communication with the first and second tube portions 841, 843.

The solenoid subunit 83 includes two magnets received in the receiving portion 842 of the tube member 84 and are spaced apart from each other.

The shaft rod 82 is movably received in the tube member 84, and extends between the magnets such that the shaft rod 82 is driven movably by the magnets toward or away from the closed end 812 of the case member 81, thereby interacting with the planetary gear set 311 of the moving unit 3. When the shaft rod 82 is moved to be engaged with the planetary gear set 311, the ring gear 312 is driven to rotate by the power unit 2. When the shaft rod 82 is moved away from and is not engaged with the planetary gear set 311, a user can manually rotate the manual unit 6 to rotate the ring gear 312 and the sliding subunit 32.

Further details and operation of the solenoid valve unit 8 are disclosed in U.S. Patent Publication No. US2017/0037937A1 and are not be described hereinafter.

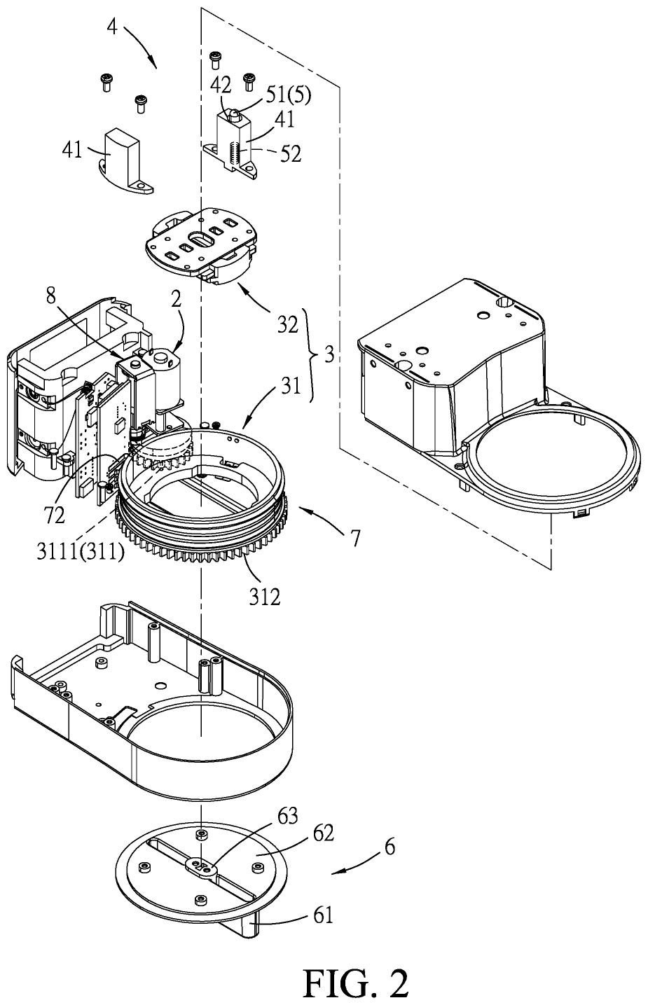

Referring to FIGS. 1 and 2, the actuating mechanism 200 is co-movably connected to the second sliding member 322 of the sliding subunit 32 of the moving unit 3, such that the rotation of the planetary gear set 311 drives a collective rotation of the ring gear 312, the sliding subunit 32, and the actuating mechanism 200 about the rotational axis (L).

In the first embodiment, the actuating mechanism 200 includes a turning unit 4 and a pin unit 5. The turning unit 4 includes two claw members 41 that are adapted for clamping a rotary switch knob of the lock mechanism or the switch mechanism therebetween and for turning the rotary switch knob during the rotation of the ring gear 312. One of the claw members 41 has an end distal from the sliding subunit 32 and is formed with a pin hole 42.

The pin unit 5 includes a pin rod 51 and a spring 52. The pin rod 51 is mounted in the one of the claw members 41, and protrudes out of the one of the claw members 41 along a third axis (Z) which is parallel to the rotational axis (L) through the pin hole 42. Also, the pin rod 51 is retractable into the one of the claw members 41 along the third axis (Z), and is adapted to be in slidable contact with a push button switch of the lock mechanism or the switch mechanism and for actuating the push button switch during the rotation of the ring gear 312. The spring 52 is disposed in the one of the claw members 41 of the turning unit 4 and is connected to the pin rod 51 such that the pin rod 51 is resiliently retractable into the one of the claw members 41 through the pin hole 42. Therefore, the switch device of the present disclosure can operate the lock mechanism or switch mechanism using the turning unit 4 if the lock or switch mechanism has a rotary switch knob, and can also operate the lock or switch mechanism using the pin unit 5 if the lock or switch mechanism has a push button switch.

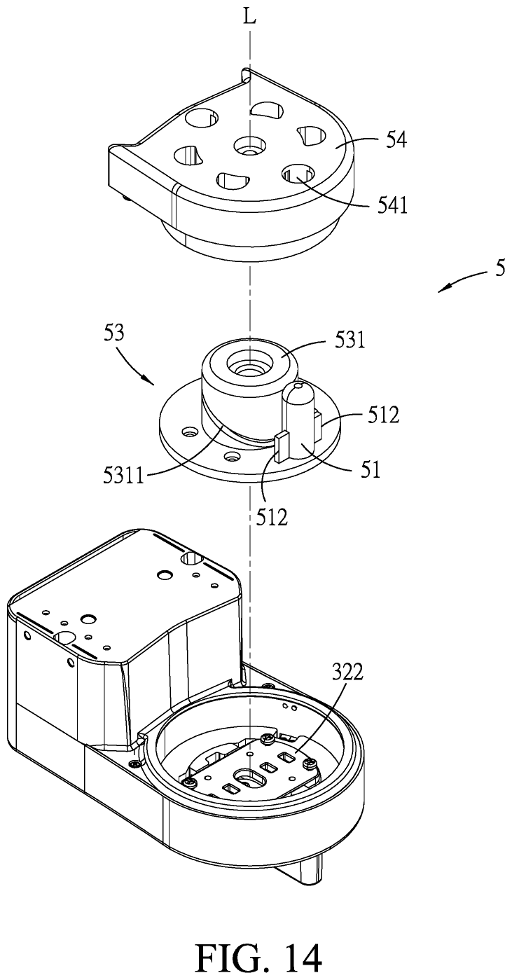

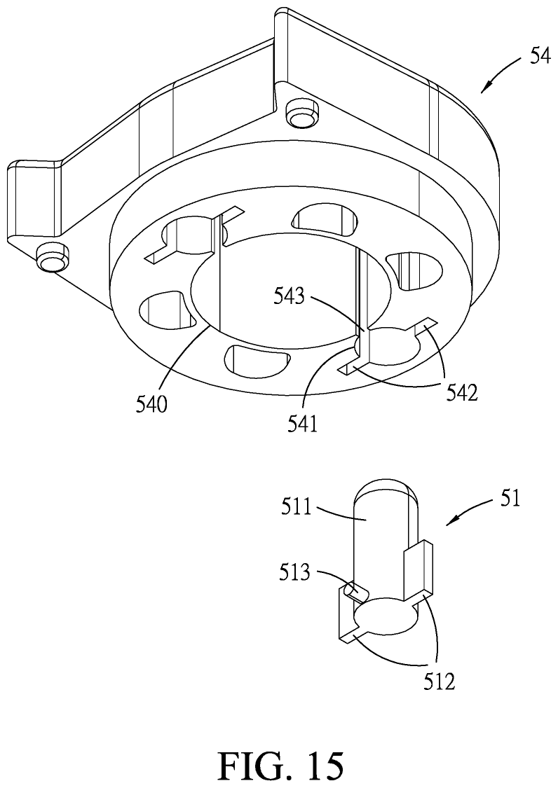

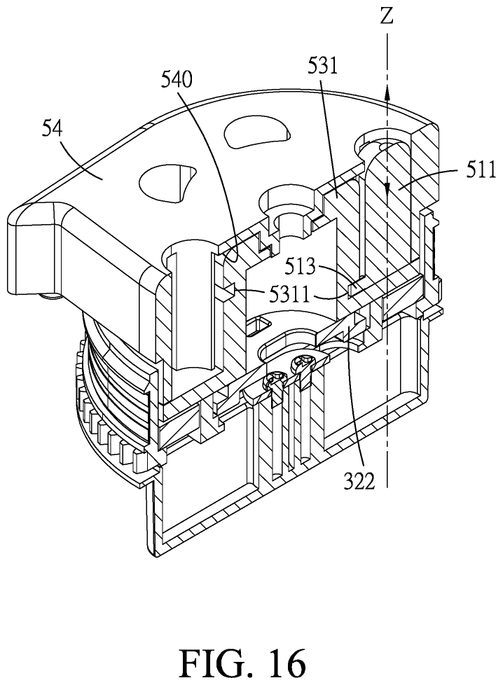

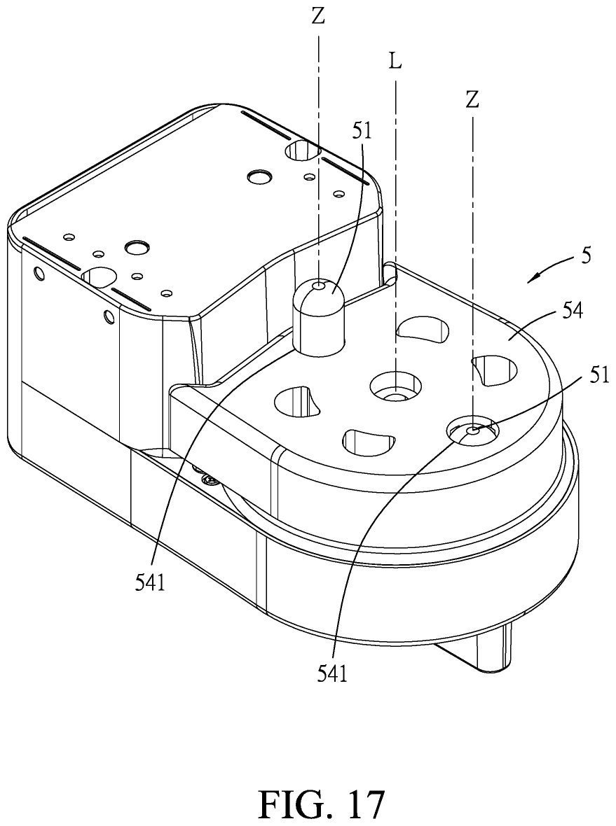

Referring to FIGS. 13 to 16, a second embodiment of the switch device according to the present disclosure is similar to the first embodiment. The difference between the two embodiments resides in configuration of the actuating mechanism 200.

In the second embodiment, the actuating mechanism 200 only includes a pin unit 5 that includes a pin rod 51, a rotating seat 53 and a cover member 54. The rotating seat 53 has a pillar body 531 that is co-movably connected to the second sliding member 322 of the sliding subunit 32 of the moving unit 3, that extends along the rotational axis (L), and that is formed with a helical groove 5311 in an outer surface thereof.

The cover member 54 covers and is connected to the rotating seat 53, and is formed with a pillar space 540, a pin hole 541, an elongated guiding slot 543 and two elongated guiding grooves 542. The pillar space 540 extends along the rotational axis (L), and receives the pillar body 531. The pin hole 541 extends along a third axis (Z) which is parallel to the rotational axis (L). The guiding slot 543 interconnects the pillar space 540 and the pin hole 541, and is parallel to the rotational axis (L). The guiding grooves 542 are respectively connected to two ends of the pin hole 541 which are distal from the guiding slot 543, and are parallel to the rotational axis (L).

The pin rod 51 has a main body 511, two first protrusions 512 and a second protrusion 513.

The main body 511 is movably disposed in the pin hole 541. Each of The first protrusions 512 protrudes from the main body 511 and engages slidably a respective one of the guiding grooves 542. The second protrusion 513 protrudes from the main body 511 through the guiding slot 543 and engages slidably the helical groove 5311 of the rotating seat 53. In such a manner, rotation of the sliding subunit 32 of the moving unit 3 and the rotating seat 53 drives the second protrusion 513 to move along the helical groove 5311, thereby driving the pin rod 51 to move linearly along the pin hole 541 under the engagement between the first protrusions 512 and the guiding grooves 542 and the engagement between the second protrusion 513 and the guiding slot 543, and to be in slidable contact with the push button switch of the lock or switch mechanism for actuating the push button switch during the rotation of the ring gear 312.

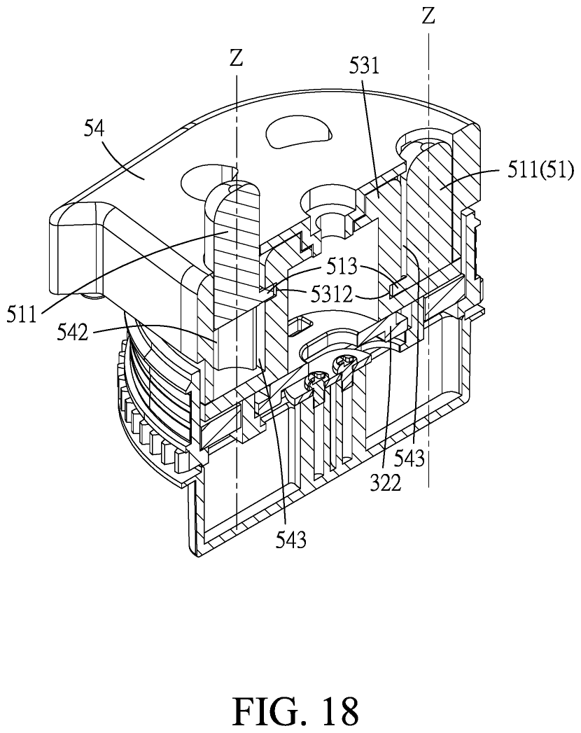

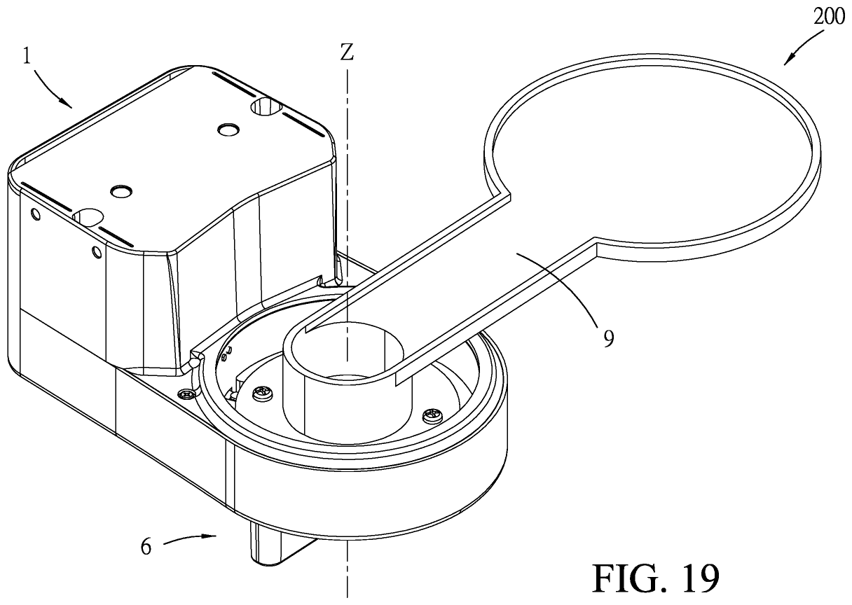

It should be noted that the number the pin rod 51 may be more than one, and the numbers of the pin hole 541, the guiding groove 542 and the guiding slot 543 may vary accordingly. For example, a variation of the second embodiment having two pin rods 51 is shown in FIGS. 17 and 18.

In this variation, the rotating seat 53 is formed with a closed-loop groove 5312 in an outer surface thereof. The closed-loop groove 5312 surrounds and is inclined relative to the rotational axis (L).

The cover member 54 has two pin holes 541, two elongated guiding slots 543 and four elongated guiding grooves 542.

The pin holes 541 respectively extend along two third axes (Z) which are parallel to the rotational axis (L). Each of the guiding slots 543 interconnects the pillar space 540 and a respective one of the pin holes 541, and is parallel to the rotational axis (L). Two of the guiding grooves 542 are respectively connected to two ends of one of the pin holes 541 which are distal from the corresponding one of the guiding slots 543, and are parallel to the rotational axis (L). The other two of the guiding grooves 542 are respectively connected to two ends of the other one of the pin holes 541 which are distal from the corresponding one of the guiding slots 543, and are parallel to the rotational axis (L).

Each of the pin rods 51 has a main body 511, two first protrusions 512 and a second protrusion 513.

For each of the pin rods 51, the main body 511 is movably disposed in a respective one of the pin holes 541. The first protrusions 512 protrude from the main body 511 and respectively and slidably engage the corresponding two of the guiding grooves 542. The second protrusion 513 protrudes from the main body 511 through a respective one of the guiding slots 543 and engaging slidably the closed-loop groove 5312 of the rotating seat 53.

In such a manner, rotation of the sliding subunit 32 of the moving unit 3 and the rotating seat 53 drives the two second protrusions 513 to move along the closed-loop groove 5312, thereby driving the two pin rods 51 to move linearly yet oppositely along the two pin holes 541. More specifically, during the rotation of the sliding subunit 32, the rotating seat 53 drives one of the pin rods 51 to move away from the sliding subunit 32 along the corresponding one of the pin holes 541, the other one of the pin rods 51 is driven to move toward the sliding subunit 32 along the other one of the pin holes 541. The resulting opposite linear movements of the pin rods 51 make the present variation especially suitable for actuating a rocker switch mechanism during the rotation of the ring gear 312.

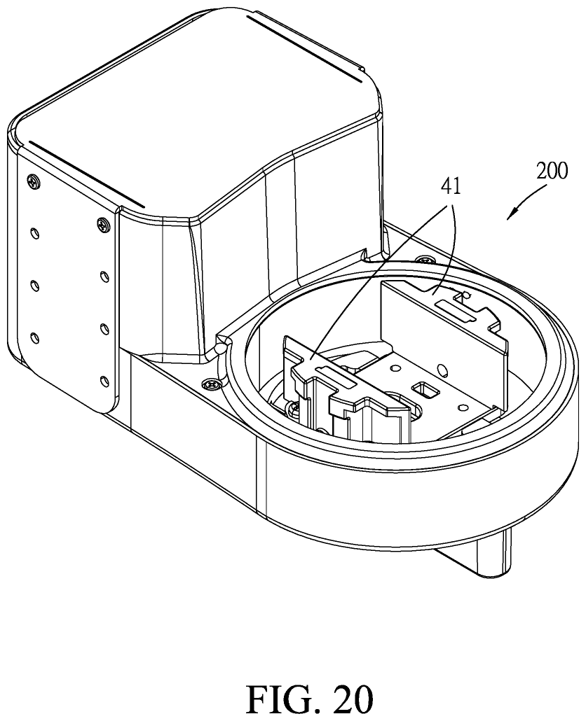

Referring to FIG. 19, a third embodiment of the switch device according to the present disclosure is similar to the first embodiment. The difference between the two embodiments resides in configuration of the actuating mechanism 200.

In the present embodiment, the actuating mechanism 200 includes a sensor blocker 9 that is co-movably connected to the second sliding member 322 of the sliding subunit 32 of the moving unit 3 such that rotation of the ring gear 312 drives the sensor blocker 9 to rotate for interacting with a proximity switch mechanism.

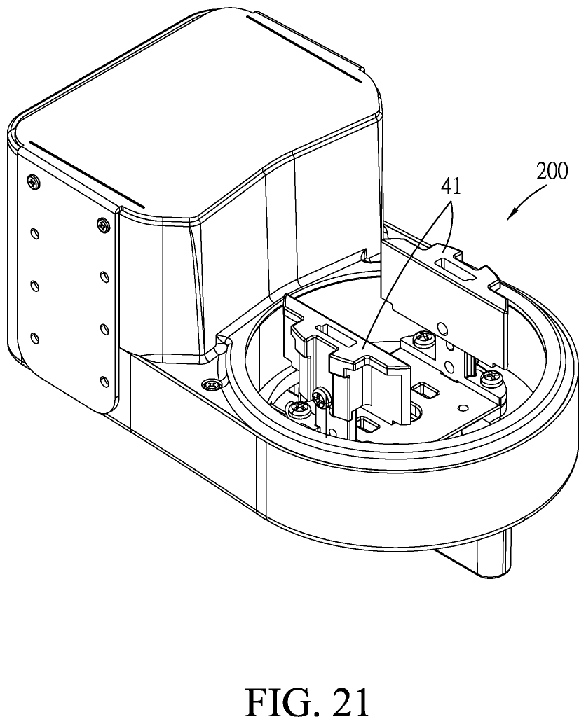

Referring to FIGS. 20 and 21, a fourth embodiment of the switch device according to the present disclosure is similar to the first embodiment. The difference between the two embodiments resides in configuration of the actuating mechanism 200.

In the present embodiment, the actuating mechanism 200 includes a turning unit 4 that includes two claw members 41. Each of the claw members 41 has a telescopic structure, such that the claw members 41 maybe adjusted to clamp rotary switch knobs of different sizes or configurations.

It should be noted that the telescopic structure may also be applied to variations of the first embodiment, so that the pin unit 5 in the first embodiment may benefit from the telescopic structure for actuating different push button switches.

In summary, the switch device of the present disclosure has the following advantages.

In virtue of the configuration of the sliding subunit 32 of the moving unit 3, the switch device is tolerant of adjustment regarding sizes of the lock or switch mechanisms, and thus has relatively better compatibility.

Lastly, since the manual unit 6 is formed with the internal space which allows the securing members 101 to extend thereinto for securing the first sliding member 321 of the sliding subunit 31, the sliding subunit 31 may be designed to be smaller or thinner without compromising the secured connection between the sliding subunit 31 and the manual unit 6, and an overall size of the switch device maybe reduced as well.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A switch device adapted for controlling operation of a lock mechanism, said switch device comprising:
a casing;
a power unit disposed in said casing;
a moving unit disposed in said casing, and including
a rotating subunit that includes a ring gear driven rotatably by said power unit about a rotational axis, and
a sliding subunit that includes
a first sliding member co-rotatably connected to said ring gear, being slidable relative to said ring gear along a first axis which is perpendicular to the rotational axis, and formed with a sliding slot that extends along the first axis,
a second sliding member co-movably connected to said first sliding member, and being slidable relative to said first sliding member along a second axis which is perpendicular to the first axis and the rotational axis, and
a first connecting member connected to said first sliding member;
a manual unit coupled co-rotatably to said ring gear;
a plurality of securing members arranged along the first axis, and extend through said first connecting member and said sliding slot of said first sliding member into said manual unit, such that said first sliding member is secured between said first connecting member and said manual unit; and
an actuating mechanism co-movably connected to said second sliding member and adapted for actuating operation of the lock mechanism during the rotation of said ring gear.

2. The switch device as claimed in claim 1, wherein said first connecting member is entirely retained in said sliding slot of said first sliding member.

3. The switch device as claimed in claim 2, wherein:
an end surface of said first sliding member opposite to said manual unit and an end surface of said second sliding member opposite to said manual unit are substantially flush with each other.

4. The switch device as claimed in claim 2, wherein said second sliding member is formed with a fastening hole such that said securing members are exposed from said fastening hole.

5. The switch device as claimed in claim 1, wherein:
said rotating subunit of said moving unit further includes a planetary gear set connected to and driven rotatably by said power unit, and meshing with said ring gear so that the rotation of said planetary gear set drives a collective rotation of said ring gear, said sliding subunit, and said actuating mechanism about the rotational axis.

6. The switch device as claimed in claim 5, wherein said actuating mechanism includes a turning unit including two claw members that are adapted for clamping a rotary switch knob of the lock mechanism therebetween and for turning the rotary switch knob during the rotation of said ring gear.

7. The switch device as claimed in claim 6, wherein each of said claw members has a telescopic structure.

8. The switch device as claimed in claim 5, wherein:
said actuating mechanism includes a turning unit including two claw members that are adapted for clamping a rotary switch knob of the lock mechanism therebetween and for turning the rotary switch knob during the rotation of said ring gear;
at least one of said claw members has an end distal from said sliding subunit and formed with a pin hole;
said actuating mechanism further includes at least one pin unit including a pin rod that is mounted in said at least one of said claw members, that protrudes out of said at least one of said claw members along a third axis which is parallel to the rotational axis through said pin hole, that is retractable into said at least one of said claw members along the third axis, and that is adapted to be in slidable contact with a push button switch of the lock mechanism and for actuating the push button switch during the rotation of said ring gear.

9. The switch device as claimed in claim 8, wherein said at least one pin unit further includes a spring disposed in said at least one of said claw members of said turning unit and connected to said pin rod such that said pin rod is resiliently retractable into said at least one of said claw members through said pin hole.

10. The switch device as claimed in claim 9, wherein each of said claw members has a telescopic structure.

11. The switch device as claimed in claim 5, wherein said actuating mechanism includes a pin unit including at least one pin rod that is adapted to be in slidable contact with a push button switch of the lock mechanism and that is adapted for pushing the push button switch during the rotation of said ring gear.

12. The switch device as claimed in claim 5, wherein said actuating mechanism includes a pin unit including:
a rotating seat that has
a pillar body co-movably connected to said sliding subunit, extending along the rotational axis, and formed with a helical groove in an outer surface thereof;
a cover member covering and being connected to said rotating seat, and formed with
a pillar space that extends along the rotational axis, and that receives said pillar body,
a pin hole that extends along a third axis which is parallel to the rotational axis,
an elongated guiding slot that interconnects said pillar space and said pin hole, and that is parallel to the rotational axis, and
an elongated guiding groove that is connected to an end of said pin hole which is distal from said guiding slot, and that is parallel to the rotational axis; and
a pin rod having
a main body movably disposed in said pin hole,
a first protrusion protruding from said main body and engaging slidably said guiding groove, and
a second protrusion protruding from said main body through said guiding slot and engaging slidably said helical groove of said rotating seat, such that rotation of said sliding subunit of said moving unit and said rotating seat drives said second protrusion to move along said helical groove, thereby driving said pin rod to move linearly along said pin hole under the engagement between said first protrusion and said at least one guiding groove and the engagement between said second protrusion and said guiding slot to be in slidable contact with a push button switch of the lock mechanism for actuating the push button switch during the rotation of said ring gear.

13. The switch device as claimed in claim 5, wherein said actuating mechanism includes a pin unit including:
a rotating seat that has
a pillar body co-movably connected to said sliding subunit, extending along the rotational axis, and formed with a closed-loop groove in an outer surface thereof, said closed-loop groove surrounding and being inclined relative to the rotational axis;
a cover member covering and being connected to said rotating seat, and formed with
a pillar space that extends along the rotational axis, and that receives said pillar body,
two pinholes that respectively extend along two third axes which are parallel to the rotational axis,
two elongated guiding slots, each of said guiding slots interconnecting said pillar space and a respective one of said pin holes, and being parallel to the rotational axis, and
two elongated guiding grooves, each of said guiding grooves connected to an end of the respective one of said pin holes which is distal from said guiding slots, and being parallel to the rotational axis; and
two pin rods, each of said pin rods having
a main body movably disposed in a respective one of said pin holes,
a first protrusion protruding from said main body and engaging slidably a respective one of said guiding grooves, and
a second protrusion protruding from said main body through a respective one of said guiding slots and engaging slidably said closed-loop groove of said rotating seat, such that rotation of said sliding subunit of said moving unit and said rotating seat drives said second protrusion to move along said closed-loop groove, thereby driving the respective one of said pin rods to move linearly along the respective one of said pin holes under the engagement between said first protrusion and the respective one of said guiding grooves and the engagement between said second protrusion and the respective one of said guiding slots to be in slidable contact with a push button switch of the lock mechanism for actuating the push button switch during the rotation of said ring gear.

14. The switch device as claimed in claim 5, wherein said actuating mechanism includes a sensor blocker that is co-movably connected to said moving unit such that rotation of said ring gear drives said sensor blocker to rotate for interacting with a proximity switch.

15. The switch device as claimed in claim 5, wherein:
said ring gear of said rotating subunit of said moving unit has
a round base wall connected between said manual unit and said first sliding member of said sliding subunit,
a plurality of teeth provided on a periphery of said base wall, and
an annular surrounding wall protruding from the periphery of said based wall, and formed with a plate hole; and
said switch device further comprises an angle sensing unit including
a brush that is disposed in said casing, and that is electrically connected to said power unit, and
a resistor member that includes
a flexible plate having an elongated plate body wrapped around said surrounding wall of said ring gear and having longitudinally-opposite end sections, each of said end sections being formed with laterally-opposite first and second end projections, said first end projections of said end sections of said flexible plate being directly connected to each other and fastened to said surrounding wall, said second end projections of said end sections of said flexible plate being directly connected to each other, extending through said plate hole of said surrounding wall, and fastened to said base wall of said rotating subunit of said moving unit, and
a conductive trail wrapped around said flexible plate, and being in slidable contact with said brush such that said conductive trail is constantly in electrical connection with said brush.

16. The switch device as claimed in claim 5, further comprising a solenoid valve unit disposed in said casing, being adjacent to said planetary gear set of said moving unit, and electrically connected to said power unit, said solenoid valve unit including:
a case member that defines a retaining space therein, and that has an opening in spatial communication with said retaining space, and a closed end opposite said opening,
a tube member that includes
a first tube portion disposed in said retaining space of said case member,
a second tube portion disposed outside of said retaining space, and
a hollow receiving portion disposed at said opening of said case member, and interconnecting and being in spatial communication with said first and second tube portions,
a solenoid subunit that includes two magnets received in said receiving portion of said tube member and being spaced apart from each other, and
a shaft rod that is movably received in said tube member, and that extends between said magnets such that said shaft rod is driven movably by said magnets toward or away from said closed end of said case member, thereby interacting with said planetary gear set of said moving unit.

17. The switch device as claimed in claim 5, wherein:
said manual unit includes
a round base member that is coupled co-rotatably to said ring gear, and that is formed with a coupling slot,
a handle that is mounted to said base member and that has an internal space being in spatial communication with said coupling slot of said base member, and
a second connecting member that is connected to said base member and that is disposed at said coupling slot; and
said securing members extend through said second connecting member and said coupling slot of said base member into said internal space of said handle.
